(19) United States
(12) Patent Application Publication
(10) Pub. No.: US 2023/0163517 A9
(43) Pub. Date: May 25, 2023

(54) END-TO-END STACKABLE WATERPROOF ELECTRICAL PLUGS

(71) Applicant: Shining Sea Trading Company, West Valley City, UT (US)

(72) Inventor: Jared Hendricks, Draper, UT (US)

(21) Appl. No.: 17/389,276

(22) Filed: Jul. 29, 2021

Related U.S. Application Data
(63) Continuation of application No. 16/673,822, filed on Nov. 4, 2019, now abandoned.
(60) Provisional application No. 62/704,030, filed on Nov. 2, 2018.

(51) Int. Cl. H01R 13/52; H01R 13/514; H01R 13/625

(52) U.S. Cl. CPC H01R 13/5219; H01R 13/514; H01R 13/625

(57) ABSTRACT

Devices and systems having a plug and socket connection for resisting or preventing liquid, moisture, vapor, and the like, from contacting the internal electrical circuitry, is provided. Such an electrical device includes a power source socket coupled to a connector and a cap seal coupled to the connector. The power source socket further includes power source wires and the connector includes power distribution wires. The connections between the power source socket and the connector, between each pair of connectors, and between the connector and the cap seal are sealed to exclude moisture/liquid from causing shorting, as is described in more detail below.

### CROSS-REFERENCE TO RELATED APPLICATIONS

This application is a continuation of U.S. patent application Ser. No. 16/673,822, filed Nov. 4, 2019, which claims the benefit of U.S. Provisional Patent Application Ser. No. 62/704,030, filed Nov. 2, 2018, each of which is incorporated herein by reference.

### BACKGROUND

Electrical connections, such as plugs, sockets, and the like, can raise concerns when used in wet or moist environments, such as environments where they may come in contact with a liquid, vapor, or the like, that is capable of causing electrical short circuits that can damage equipment and/or lead to injury or even death. Examples of such nonlimiting environments includes outdoor locations where electrical connections can be exposed to a wide range of temperature, moisture, and weather conditions. In other nonlimiting examples, such electrical connections can be utilized in indoor environments where liquid and/or moisture can be a concern, such as disaster cleanup sites, manufacturing facilities, construction sites, and the like.

### BRIEF DESCRIPTION OF THE DRAWINGS

FIG. 1A illustrates an electrical device in accordance with an example embodiment;

FIG. 1B illustrates an electrical device in accordance with an example embodiment;

FIG. 1C illustrates an electrical device in accordance with an example embodiment;

FIG. 2A illustrates an engagement seal of an electrical device in accordance with an example embodiment;

FIG. 2B illustrates an engagement seal of an electrical device in accordance with an example embodiment;

FIG. 3A illustrates an electrical device in accordance with an example embodiment;

FIG. 3B illustrates an electrical device in accordance with an example embodiment;

FIG. 3C illustrates an electrical device in accordance with an example embodiment;

FIG. 4A illustrates an electrical device in accordance with an example embodiment;

FIG. 4B illustrates an electrical device in accordance with an example embodiment;

FIG. 4C illustrates an electrical device in accordance with an example embodiment;

FIG. 4D illustrates an electrical device in accordance with an example embodiment;

FIG. 4E illustrates an electrical device in accordance with an example embodiment;

FIG. 4F illustrates an electrical device in accordance with an example embodiment;

FIG. 5 illustrates an electrical device in accordance with an example embodiment;

FIG. 6 illustrates an electrical device in accordance with an example embodiment;

FIG. 7A illustrates an electrical device in accordance with an example embodiment;

FIG. 7B illustrates an electrical device in accordance with an example embodiment;

FIG. 8A illustrates an electrical device in accordance with an example embodiment;

FIG. 8B illustrates an electrical device in accordance with an example embodiment;

FIG. 8C illustrates an electrical device in accordance with an example embodiment;

FIG. 9 illustrates an electrical device in accordance with an example embodiment; and

FIG. 10 illustrates an electrical device in accordance with an example embodiment.

### DESCRIPTION OF EMBODIMENTS

Although the following detailed description contains many specifics for the purpose of illustration, a person of ordinary skill in the art will appreciate that many variations and alterations to the following details can be made and are considered included herein. Accordingly, the following embodiments are set forth without any loss of generality to, and without imposing limitations upon, any claims set forth. It is also to be understood that the terminology used herein is for describing particular embodiments only and is not intended to be limiting. Unless defined otherwise, all technical and scientific terms used herein have the same meaning as commonly understood by one of ordinary skill in the art to which this disclosure belongs. Also, the same reference numerals in appearing in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details may be provided, such as examples of layouts, distances, etc., to provide a thorough understanding of various embodiments. One skilled in the relevant art will recognize, however, that such detailed embodiments do not limit the overall concepts articulated herein but are merely representative thereof. One skilled in the relevant art will also recognize that the technology can be practiced without one or more of the specific details, or with other methods, components, layouts, etc. In other instances, well-known structures, materials, or operations may not be shown or described in detail to avoid obscuring aspects of the disclosure.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open-ended term in this written description, like “comprising” or “including,” it is understood that direct support should be afforded also to “consisting essentially of” language as well as “consisting of” language as if stated explicitly and vice versa.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, distances, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of phrases including “an example” or “an embodiment” in various places throughout this specification are not necessarily all referring to the same example or embodiment.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art.

An initial overview of embodiments is provided below, and specific embodiments are then described in further detail. This initial summary is intended to aid readers in understanding the disclosure more quickly, and is not intended to identify key or essential technological features, nor is it intended to limit the scope of the claimed subject matter.

### DESCRIPTION OF EXAMPLE EMBODIMENTS

Electrical connections, such as plugs, sockets, and the like, can raise concerns when used in wet or moist environments, such as environments where they may come in contact with a liquid, vapor, or the like, that is capable of causing electrical short circuits that can damage equipment and/or lead to injury or even death. Examples of such nonlimiting environments includes outdoor locations where electrical connections can be exposed to a wide range of temperature, moisture, and weather conditions. In other nonlimiting examples, such electrical connections can be utilized in indoor environments where liquid and/or moisture can be a concern, such as disaster cleanup sites, manufacturing facilities, construction sites, and the like. In some cases, electrical connections can be utilized in providing electricity for decorative lighting, such as, for example, outdoor decorative lighting for holidays, aesthetics, advertising, and the like. In one nonlimiting example, outdoor decorative strings of lights can be coupled to trees, bushes, fences, or other landscape structures, as well as building structures, signage, houses, and the like. In many cases, a string of lights can include a plug with at least two electrical contacts, or prongs, configured to insert into an electrical outlet, power supply, surge protector, extension cord, or the like, in order to provide power to the lights on the string of lights. At least two insulated electrical wires electrically are generally coupled to the electrical prongs and extend from the plug with lights spaced along the wires at regular or irregular intervals. In order to power multiple strings of lights with a single electrical connection, in some examples the string of lights can include a socket configured to receive and make electrical contact with the electrical prongs (a second set of electrical prongs) of a plug of another string of lights. When inserted into the socket, the second set of electrical prongs electrically couple to corresponding socket contacts and thus electrically couple to the electrical connection through the first set of electrical prongs to receive power. In some examples, strings of lights can be coupled in series, where each string of lights has a plug on one end of the string and a socket on the opposite end of the string. In other examples, strings of lights can include a single connector on one end having both a plug and a socket. In this configuration, the plug side of the single connector of each subsequent string of lights is plugged into the socket side of the single connector of an adjacent string of lights. In this manner, a “backbone” of single connectors is formed with strings of lights extending therefrom in a parallel orientation.

In addition to strings of lights, in some examples a power cord to an electrical tool, an extension cord, or the like, can similarly include a plug with at least two electrical contacts, or prongs, configured to insert into an electrical outlet, power supply, surge protector, extension cord, or the like, in order to provide power. A power cord for an electrical tool can be plugged directly into an electrical power outlet or into an extension cord that is plugged into an electrical power outlet. Furthermore, multiple extension cords can be coupled in series together to provide power to more distant locations.

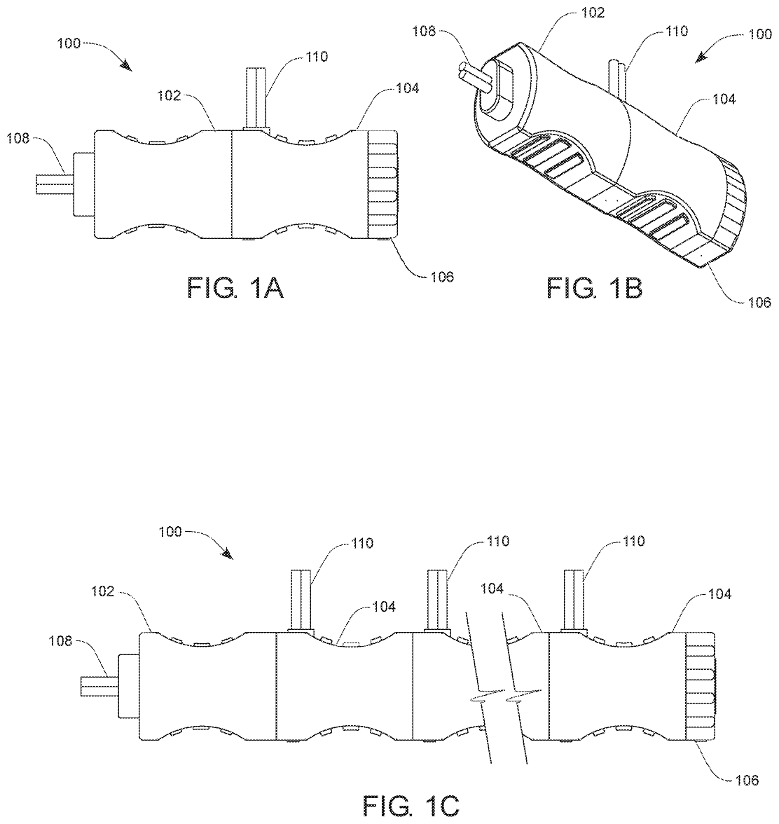

One example embodiment of an electrical device having a plug and socket connection for resisting or preventing liquid, moisture, vapor, and the like, from contacting the internal electrical circuitry, is shown in FIGS. 1A-1C. FIG. 1A shows an electrical assembly 100 including a power source socket 102 coupled to a connector 104 and a cap seal 106 coupled to the connector 104. The power source socket 102 further includes power source wires 108 and the connector 104 includes power distribution wires 110. While the power source wires 108 and the power distribution wires 110 are shown having a two-wire configuration, such is not limiting, and any number of wires and wiring configurations are contemplated. FIG. 1B shows an example isometric view and FIG. 1C shows an example having multiple connectors 104 coupled between the power source socket 102 and the cap seal 106. As such, multiple connectors 104 can be coupled to the power source socket 102 to provide power along multiple power distribution wires 110 in a given electrical assembly 100. The connections between the power source socket 102 and the connector 104, between each pair of connectors 104, and between the connector 104 and the cap seal 106 are sealed to exclude moisture/liquid from causing shorting, as is described in more detail below.

The power distribution wires can be coupled to a variety of electrical devices, both decorative and nondecorative, which are not considered to be limiting. In one example, however, an electrically powered decorative device can be electrically coupled to the power distribution wires. Nonlimiting examples of such a decorative device can include decorative lighting, moving decorations, inflation devices for inflated decorations, sound devices, and the like, including combinations thereof. Additionally, in some examples all of the power distribution wires in an electrical assembly can be coupled to the same type of decorative devices, such as for example, decorative lighting. In other examples, power distribution wires in the same electrical assembly can be coupled to different types of decorative devices. As one nonlimiting example, an electrical assembly can include a plurality of power distribution wires coupled to decorative lighting and at least one set of power distribution wires can be coupled to an inflatable lawn decoration. In some cases, the power distribution wires to a decorative device such as a lawn decoration can also power decorative lighting or other electrical device associated with the inflatable lawn device.

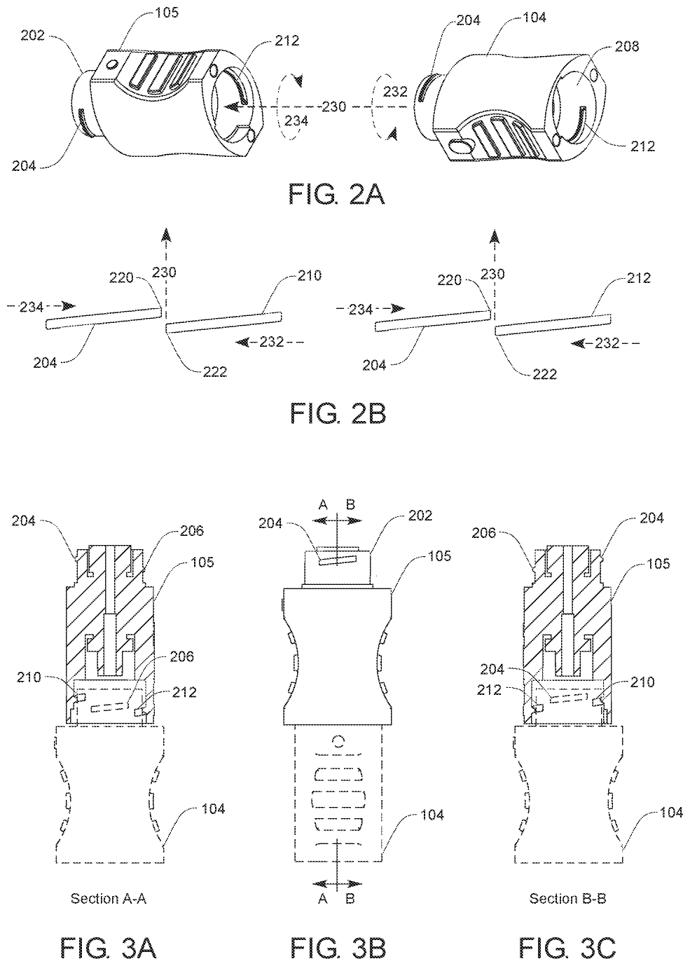

FIG. 2A shows an example illustration of two connectors, a first connector 104 and a second connector 105, uncoupled and oriented 90° relative to one another along a common central axis. The connectors 104, 105 include a plug 202 and a socket 208. The plug 202 further includes an upper plug engagement 204 and a lower plug engagement 206 (not shown in FIG. 2A). The socket 208 further includes an upper socket engagement 210 (not shown in FIG. 2A) and a lower socket engagement 212. In some examples, the upper plug engagement 204 and the lower plug engagement 206 can each have a slope that at least approximate the slopes of the upper socket engagement 210 and the lower socket engagement 212, respectively. When the plug 202 of the first connector 104 is inserted into the socket 208 of a second connector 105, as shown by arrow 230, the upper-most end 220 of the upper plug engagement 204 of the first connector 104 is positioned above the lower-most end 222 of the upper socket engagement 210 of the second connector 105 (See FIG. 2B). When positioned in such a manner, rotating either the first connector 104 in a direction indicated by 232, the second connector 105 in a direction indicated by 234, or both, the upper plug engagement 204 rides along the slope of the upper socket engagement 212 to press the first connector 104 and the second connector 105 closer together in direction 230, thus increasing the seal between the two connectors against moisture, liquid, and the like.

Similarly, when the plug 202 of the first connector 104 is inserted into the socket 208 of a second connector 105, as shown by arrow 230, the upper-most end 220 of the lower plug engagement 206 of the first connector 104 is positioned above the lower-most end 222 of the lower socket engagement 212 of the second connector 105 (See FIG. 2B). When positioned in such a manner, rotating either the first connector 104 in a direction indicated by 232, the second connector 105 in a direction indicated by 234, or both, the lower plug engagement 206 rides against the lower socket engagement 212 to press the first connector 104 and the second connector 105 closer together in direction 230, thus increasing the seal between the two connectors against moisture, liquid, and the like.

FIGS. 3A-3C show an example of a pair of connectors, a first connector 104 and a second connector 105, inserted together but prior to rotation. The first connector 104 is represented with dashed lines to allow differentiation between the connectors at the interface. FIG. 3B shows a side view of the plug assembly, FIG. 3A shows a cross section of FIG. 3B taken in the A-A direction and FIG. 3C shows a cross section of FIG. 3B taken in the B-B direction. By rotating the second connector 104 in FIG. 3A to the left, the lower plug engagement 206 engages and slides along the lower socket engagement 212. Due to the complimentary slopes of the lower plug engagement 206 and the lower socket engagement 212, the rotation causes the two connectors 104, 105 to be pulled and tightened together to thus form a sealed connection. Similarly, rotation of the first connector 104 in FIG. 3C causes the upper plug engagement 204 to engage and slide along the upper socket engagement 210 and the complimentary slopes of the upper plug engagement 204 and the upper socket engagement 210 cause the two connectors 104, 105 to be pulled and tightened together to thus form a sealed connection. In some examples the connection can be further sealed using a gasket or other sealing device.

While FIGS. 2A and 3A-3C show a pair of connectors 104, 105, it is noted that additional connectors can be further coupled to the connector assembly to continue the chain. Once the final connector has been coupled thereto, a cap seal 106 can be similarly inserted and rotated within the socket 208 to provide a terminal seal to the plug assembly. Additionally, the insertion and rotation shown in these figures applies to coupling the plug of connector to the socket 208 of a power source.

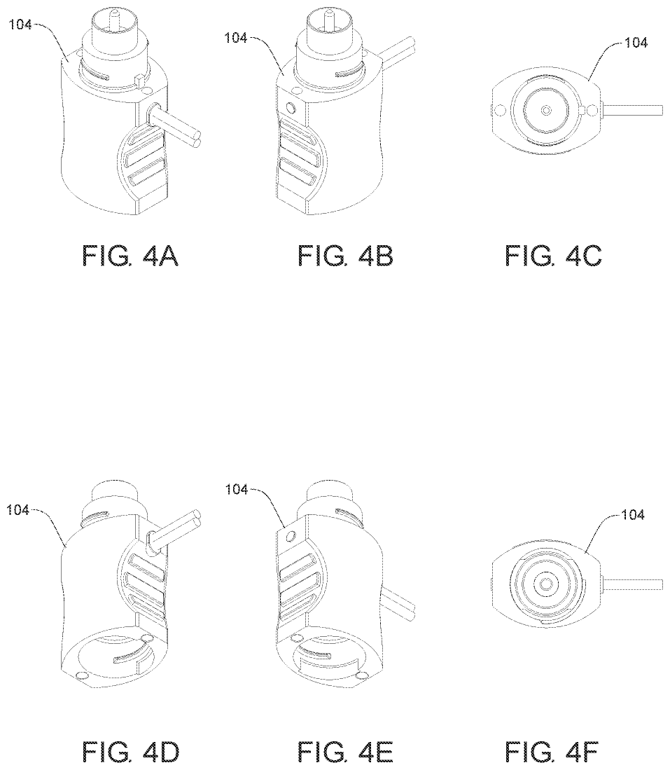

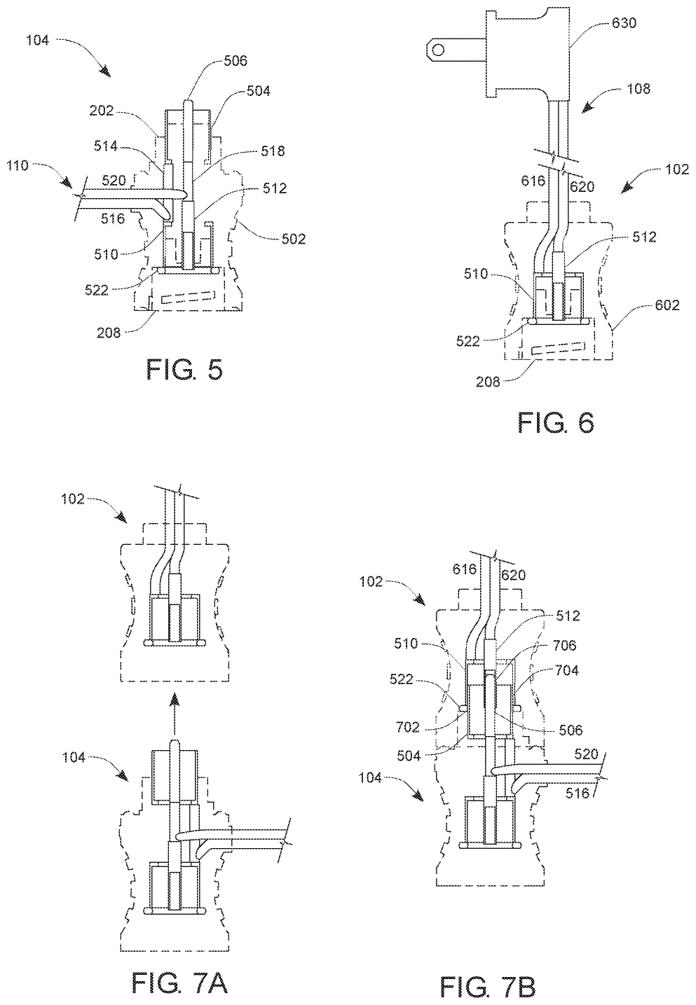

FIGS. 4A-4F show various views of an exemplary connector 104, including isometric views (FIGS. 4A, 4B, 4D, and 4E), a top-down view (FIG. 4C), and a bottom-up view (FIG. 4F). FIG. 5 illustrates connector 104 with the external housing 502 shown as dashed lines to improve the clarity of the internal components. The connector 104 includes an outer plug conductor 504 and an inner plug conductor 506 at the plug 202 end and an outer socket conductor 510 and an inner socket conductor 512 at the socket 208 end. The outer plug conductor 504 and the outer socket conductor 510 can be electrically coupled together by an outer conductor 514, which can be electrically coupled to a first distribution wire 516 of the power distribution wires 110. The inner plug conductor 506 and the inner socket conductor 512 can be electrically coupled together by an inner conductor 518, which can be electrically coupled to a second distribution wire 520 of the power distribution wires 110. In some examples, the inner plug conductor 506 and the inner socket conductor 512 can be electrically coupled together by the inner socket conductor 512 (not shown). Additionally, the outer plug and outer socket conductors 504, 510 are electrically insulated from the inner plug and inner socket conductors 506, 512. A gasket 522 can be positioned around the base of the outer socket conductor 510 to provide a seal between the outer socket conductor 510 and an outer plug conductor 504 of a subsequent connector 104 coupled thereto.

FIG. 6 illustrates an example of a power source socket 102 with the external housing 602 shown as dashed lines to improve the clarity of the internal components. The power source socket 102 includes an outer socket conductor 510 and an inner socket conductor 512 at the socket 208 end. The outer socket conductor 510 can be electrically coupled to a first source wire 616 of the power source wires 108 and the socket conductor 512 can be electrically coupled to a second source wire 620 of the power source wires 108. An electrical power plug 630 can provide power to the power source wires 108 when inserted into an electrical outlet (not shown).

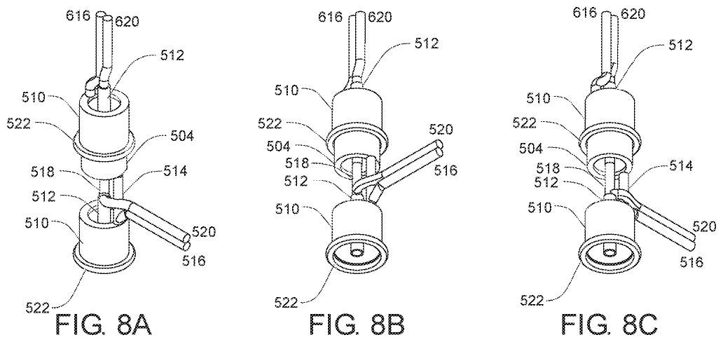

FIG. 7A shows a connector 104 being inserted into a power source socket 102. FIG. 7B shows the connector 104 coupled to the power source socket 102, which in some examples can be accomplished as shown in FIG. 2. The gasket 522 can provide a seal 702 between the outer plug conductor 504 and the outer socket conductor 510. The outer plug conductor 504 and the outer socket conductor 510 thus make electrical contact 704 with one another, and thus provide a conductive pathway between the first source wire 616 and the first distribution wire 516. Similarly, the inner plug conductor 506 and the inner socket conductor 512 make electrical contact 706 with one another and thus provide a conductive pathway between the second source wire 620 and the second distribution wire 520. FIGS. 8A-8C show isometric views of the internal electrical components separated from the plug housings of the assembly shown in FIG. 7B.

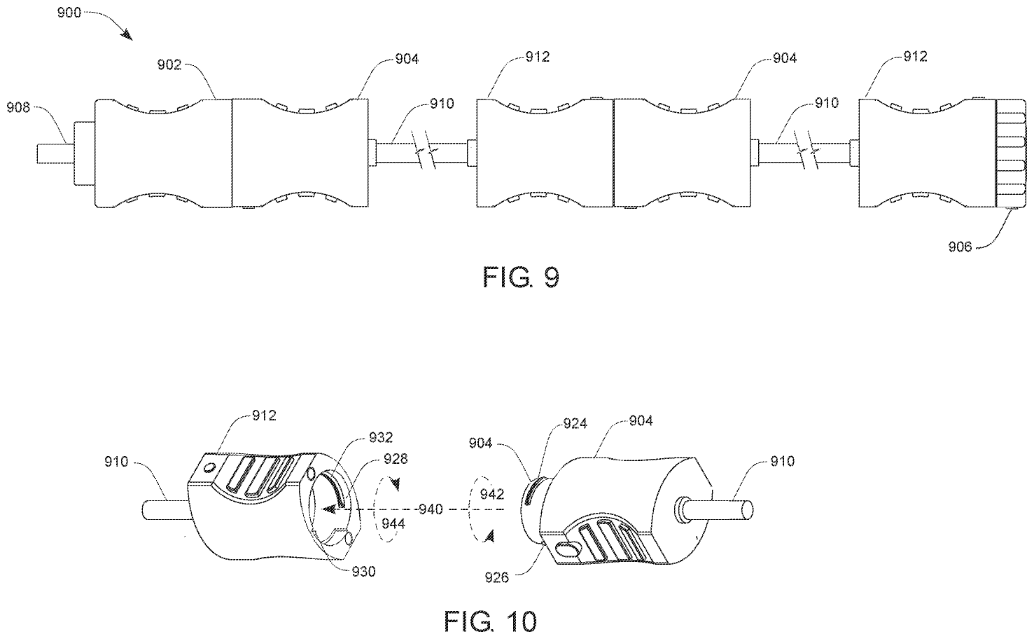

In another cases, an electrical device can have a plug and a socket connector on each end of a length of distribution wire. Such devices can include strings of lights, power cords to devices such as electrical tools, decorations or the like, extension cords, etc. In one example embodiment, such a device can have a plug and socket connection for resisting or preventing liquid, moisture, vapor, and the like, from contacting the internal electrical circuitry. As is shown in FIG. 9, an electrical assembly 900 includes a power source socket 902 coupled to a plug connector 904. The power source socket 902 further includes power source wires 908 and the plug connector 104 includes power distribution wires 910 extending from the plug connector 104 opposite power source socket 902. The power distribution wires 910 electrically couple to a socket connector 912, which is in turn coupled to a subsequent plug connector 904. FIG. 9 shows a linear chain comprised of electrical subunits of a plug connector 904 and a socket connector 912 wired together by a length of power distribution wires 910. The plug connector 904 of each electrical subunit is coupled to the socket connector 912 of either an adjacent socket connector 912 or a power source socket 902. It is noted that the connections between the plug connector 904 and the socket connector 912 and between the plug connector and the power socket source 902 provide a seal for resisting or preventing liquid, moisture, vapor, and the like, from contacting the internal electrical circuitry. Similar to that shown in FIGS. 1A-1C, a cap seal 906 is shown coupled to a socket connector 912 to seal the electrical chain assembly. The power source wires 108 and the power distribution wires 110 are shown within a single insulating sheath, which can contain any number of wires and wiring configurations. In one example, the power distribution wires can include a plurality of decorative lights electrically coupled therealong.

FIG. 10 shows an example illustration of a plug connector 904 and a socket connector 912, uncoupled and oriented 90° relative to one another along a common central axis. The plug connector 904 includes a plug 922, which further includes an upper plug engagement 924 and a lower plug engagement 926. The socket connector 912 includes a socket 928, which further includes an upper socket engagement 930 and a lower socket engagement 932. In some examples, the upper plug engagement 924 and the lower plug engagement 926 can each have a slope that at least approximate the slopes of the upper socket engagement 930 and the lower socket engagement 932, respectively. When the plug 904 of the plug connector 904 is inserted into the socket 928 of the second socket connector 912, as shown by arrow 940. The various engagements interact as described above and shown in FIG. 2B. When positioned in such a manner, rotating either the plug connector 904 in a direction indicated by 942, the socket connector 912 in a direction indicated by 944, or both, the upper plug engagement 924 rides along the slope of the upper socket engagement 930 to press the plug connector 904 and the socket connector 912 closer together in direction 940, thus increasing the seal between the two connectors against moisture, liquid, and the like.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. An electrical device, comprising:
a first connector, including;
a plug body segment having a plug end, the plug end including;
a plug engagement disposed along an outer surface of the plug end; and
a second connector, including;
a socket body segment having a socket end structurally configured to receive the plug end along a central axis, the socket end, including;
a socket engagement disposed along an inner surface of the socket end;
wherein the plug engagement and the socket engagement are structurally aligned with one another such that, upon rotation of the plug end in the socket end around the central axis, the plug body segment and the socket body segment are pulled together with sufficient force to create a seal against moisture and liquid between the plug body segment and the socket body segment.

2. The electrical device of claim 1, wherein the plug engagement and the socket engagement are positioned at a corresponding slope relative to one another, such that, upon rotation of the plug end in the socket end around the central axis, the plug engagement and the socket engagement slide along one another at the corresponding slope to pull the plug body segment and the socket body segment together with sufficient force to create the seal against moisture and liquid between the plug body segment and the socket body segment.

3. The electrical device of claim 2, wherein the corresponding slope is at an oblique angle relative to the central axis.

4. The electrical device of claim 3, wherein:
the plug engagement further includes;
a plug engagement upper end; and
a plug engagement lower end, wherein the plug engagement lower end is positioned closer to the plug body segment compared to the plug engagement upper end; and
the socket engagement further includes;
a socket engagement upper end; and
a socket engagement lower end, wherein the socket engagement lower end is positioned closer to the socket body segment compared to the socket engagement upper end.

5. The electrical device of claim 4, wherein, upon rotation of the plug end in the socket end around the central axis, the plug engagement upper end is positioned to engage the socket engagement lower end and slide along the socket engagement toward the socket engagement upper end to pull the plug body segment and the socket body segment together with sufficient force to create the seal against moisture and liquid between the plug body segment and the socket body segment.

6. The electrical device of claim 4, wherein, upon rotation of the plug end in the socket end around the central axis, the plug engagement lower end is positioned to engage the socket engagement upper end and slide along the socket engagement toward the socket engagement lower end to pull the plug body segment and the socket body segment together with sufficient force to create the seal against moisture and liquid between the plug body segment and the socket body segment.

7. The electrical device of claim 1, further comprising:
an additional plug engagement disposed on the outer surface of the plug end at an opposite side of the central axis from the plug engagement; and
an additional socket engagement disposed on the inner surface of the socket end at an opposite side of the central axis from the socket engagement;
wherein the additional plug engagement and the additional socket engagement are structurally aligned with one another such that, upon rotation of the plug end in the socket end around the central axis, the plug body segment and the socket body segment are pulled together with sufficient force to create a seal against moisture and liquid between the plug body segment and the socket body segment.

8. The electrical device of claim 7, wherein the plug engagement and the socket engagement are positioned at an additional corresponding slope relative to one another, such that, upon rotation of the plug end in the socket end around the central axis, the plug engagement and the socket engagement slide along one another at the additional corresponding slope to pull the plug body segment and the socket body segment together with sufficient force to create the seal against moisture and liquid between the plug body segment and the socket body segment.

9. The electrical device of claim 8, wherein the additional corresponding slope is at an oblique angle relative to the central axis.

10. The electrical device of claim 9, wherein:
the additional plug engagement further includes;
an additional plug engagement upper end; and
an additional plug engagement lower end, wherein the additional plug engagement lower end is positioned closer to the plug body segment compared to the additional plug engagement upper end; and
the socket engagement further includes;
an additional socket engagement upper end; and
an additional socket engagement lower end, wherein the additional socket engagement lower end is positioned closer to the socket body segment compared to the additional socket engagement upper end.

11. The electrical device of claim 10, wherein, upon rotation of the plug end in the socket end around the central axis, the additional plug engagement upper end is positioned to engage the additional socket engagement lower end and slide along the additional socket engagement toward the additional socket engagement upper end to pull the plug body segment and the socket body segment together with sufficient force to create the seal against moisture and liquid between the plug body segment and the socket body segment.

12. The electrical device of claim 10, wherein, upon rotation of the plug end in the socket end around the central axis, the additional plug engagement lower end is positioned to engage the additional socket engagement upper end and slide along the additional socket engagement toward the additional socket engagement lower end to pull the plug body segment and the socket body segment together with sufficient force to create the seal against moisture and liquid between the plug body segment and the socket body segment.

13. The electrical device of claim 1, wherein:
the plug engagement further includes a plug conductor positioned at the plug end; and
the socket engagement further includes a socket conductor positioned at the socket end, wherein the plug conductor is electrically coupled to the socket conductor upon rotation of the plug end in the socket end around the central axis.

14. The electrical device of claim 13, wherein the plug conductor and the socket conductor are positioned radially around at least a portion of the central axis.

15. The electrical device of claim 14, wherein an outer surface of the plug conductor is structurally configured to electrically couple with an inner surface of the socket conductor.

16. The electrical device of claim 1, wherein the first connector further comprises a plug body segment socket end opposite the plug end and structurally configured to receive a plug end.

17. The electrical device of claim 1, wherein the second connector further comprises a socket segment plug end opposite the socket end and structurally configured to receive a socket end.
